(19) United States
(12) Patent Application Publication
(10) Pub. No.: US 2007/0121104 A1
(43) Pub. Date: May 31, 2007

(54) Techniques for reducing optical noise in metrology systems

(76) Inventors: James L. Hendrix, Livermore, CA (US); David Y. Wang, Fremont, CA (US)

Correspondence Address: STALLMAN & POLLOCK LLP, 353 SACRAMENTO STREET, SUITE 2200, SAN FRANCISCO, CA, 94111, US

(21) Appl. No.: 10/823,452

(22) Filed: Apr. 13, 2004

Related U.S. Application Data
(60) Provisional application No. 60/464,065, filed on Apr. 18, 2003.

(51) Int. Cl. G01N 21/88

(52) U.S. Cl. 356/237.2

(57) ABSTRACT

A first method for fabricating low-noise optical components for use in optical metrology systems includes shaping a glass substrate to obtain a desire shape and then coating the glass substrate with a reflective coating. A second method includes shaping a glass master die to a desired shape and then using the glass master to form a glass substrate to the desire shape. A third method includes diamond turning a substrate to a desired shape and then polishing the substrate to meet two surface conditions which in turn ensures that the scattered light is minimized and the metrology instruments performance is greatly increased. These conditions relate to a measurement of encircled energy compared to an ideal diffraction limited component of the same focal length and diameter.

### PRIORITY CLAIM

The present application claims priority to U.S. Provisional Patent Application Ser. No. 60/464,065, filed Apr. 18, 2003 the disclosure of which is incorporated in this document by reference.

### TECHNICAL FIELD

The subject invention relates to optical devices used to non-destructively evaluate semiconductor wafers. In particular, the present invention relates to techniques for reducing optical scatter created by optical components within metrology systems.

### BACKGROUND OF THE INVENTION

As geometries continue to shrink, manufacturers have increasingly turned to optical techniques to perform non-destructive inspection and analysis of semi-conductor wafers. The basis for these techniques is the notion that a subject may be examined by analyzing the reflected energy that results when a probe beam is directed at the subject. Ellipsometry and reflectometry are two examples of commonly used optical techniques. For the specific case of ellipsometry, changes in the polarization state of the probe beam are analyzed. Reflectometry is similar, except that changes in magnitude are analyzed. Scatterometry is a related technique that measures the diffraction (optical scattering) that the subject imparts to the probe beam.

Techniques of this type may be used to analyze a wide range of attributes. This includes film properties such as thickness, crystallinity, composition and refractive index. Typically, measurements of this type are made using reflectometry or ellipsometry as described more fully in U.S. Pat. Nos. 5,910,842 and 5,798,837 both of which are incorporated in this document by reference. Critical dimensions (CD) including line spacing, line width, wall depth, and wall profiles are another type of attributes that may be analyzed. Measurements of this type may be obtained using monochromatic scatterometry as described in U.S. Pat. Nos. 4,710,642 and 5,164,790 (McNeil). Another approach is to use broadband light to perform multiple wavelength spectroscopic reflectometry measurements. Examples of this approach are found in U.S. Pat. No. 5,607,800 (Ziger); U.S. Pat. No. 5,867,276 (McNeil); and U.S. Pat. No. 5,963,329 (Conrad). Still other tools utilize spectroscopic ellipsometric measurement. Examples of such tools can be found in U.S. Pat. No. 5,739,909 (Blayo) and U.S. Pat. No. 6,483,580 (Xu). Each of these patents and publications are incorporated herein by reference.

Optical metrology tools, such as ellipsometers, reflectometers and scatterometers typically include an array of different optical components such as beam splitters, apertures, lenses and mirrors. Each of these components is a potential source of optical scatter and distortion. As the precision of optical metrology tools increases to match shrinking semiconductor geometries, scatter and distortion become increasingly problematic and controlling both becomes an increasingly important goal.

Prior art curved mirrors are classified as either on-axis or off-axis types based on the position of the incident chief ray relative to the mirrors' surface vertices. In an on-axis mirror, the incident chief ray centers on the mirror's surface vertex. In an off-axis mirror, the incident chief ray is off-centered from the mirror's surface vertex so there is physical separation between the incident and reflected beams. Off-axis mirrors are commonly used in non-obscured optical systems.

In optical metrology systems, off-axis parabolic mirrors, off-axis elliptical mirrors and off-axis mirrors with general aspheric departures are commonly used to direct and manipulate optical beams.

Parabolic mirrors are a special type of reflective component. Mirrors of this type sharply focus an axially collimated beam to a point. They typically exhibit very low or no spherical aberration on-axis and no chromatic aberration. As shown in FIG. 1, an off-axis parabolic mirror's a focal point positioned outside of the mirror's beam path. FIG. 2A shows a typical off-axis parabolic mirror and its associated mounting fixture.

Elliptical mirrors are another special type of reflective component. Mirrors of this type sharply focus a point source to another point. They typically exhibit very low aberration on-axis and no chromatic aberration. As shown in FIG. 2B, an off-axis elliptical mirror's focal point is positioned outside of the mirror's beam path.

Optical surface errors introduce optical scatter and distortions and cause light to scatter away from its intended path. The scattered light reduces efficiency (since it is not available on the intended path) and stray light typically interferes with intended signal detection and analysis (e.g., signal to noise). For these reasons, manufacturers have continually sought methods for decreasing the surface errors of optical components.

In the prior art, surface errors are typically classified in terms of surface form error, mid-spatial frequency error, and micro roughness error. Surface form error is typically specified in terms of power and irregularity. Micro roughness is generally specified as an RMS value with a spatial period of less than 1/100 of the component's optical clear aperture. Mid-spatial frequency error is generally spans the domain between surface form error and surface micro-roughness. An example of mid-spatial frequency error is the periodic structures typically seen on diamond turned optic surfaces. Many prior art techniques are available to measure surface errors of an optical component. The most typical instrument for surface error measurement is an interferometer. Current component metrology approaches are generally good at defining the surface form error and the surface micro-roughness errors and they are very cumbersome to use in defining mid-spatial frequency errors.

In the prior art, off-axis aspheric mirrors are typically constructed using a substrate that is most commonly made of aluminum, copper or other metal. The substrate is shaped by cutting (typically by diamond turning) until the desired shape is achieved. Additional layers, such as nickel may be added. The diamond turned optical component is often post polished to reduce surface roughness. In general, best practice average RMS surface roughness is about 20 Angstroms RMS. Diamond turning marks left on the optical surfaces make surface roughness highly dependent on use orientation. The resulting structure is generally coated to prevent oxidation.

Optical components manufactured using techniques of this nature have proven to be adequate for optical metrology applications. As metrology systems are improved to study sub-Angstrom features, however, the surface errors of these components become increasingly problematic. Improving the quality of these components can be difficult. This is especially true for off-axis parabolic mirrors whose complex shapes make traditional cutting and polishing techniques less effective.

### SUMMARY OF THE INVENTION

The present invention provides a method for increasing the accuracy of optical metrology tools. For this method, low scatter mirrors are produced using one of the fabrication methods discussed below. The low scatter mirrors are used in place of traditional optics to reduce optical noise. In turn, this allows measurement accuracy to be increased while maintaining or decreasing measurement spot size.

One method for producing appropriate mirrors (including off-axis aspheric mirrors) starts with a glass substrate. Each glass substrate is machined to create a desired shape. Typically, this is performed using computer-numeric-control (CNC) techniques. Each machined substrate is then coated with a reflective coating, such as aluminum and protected with a sealer. The overall result is a mirror that has superior surface smoothness reducing noise and distortion within optical metrology systems.

A second method for fabricating low-scatter optical components uses a press forming technique to create mirrors, including off-axis aspheric mirrors, from a negative master, deformable coating, compliant epoxy layer and a ridged substrate. The press forming technique uses a die having male and female halves, a negative master shape form, and a substrate. The deformable coating is positioned between the negative master and the epoxy layer applied to the mating surface of the substrate all sandwiched between two halves of the die. The die is then closed under pressure, imparting the shape of the master into the deformable coating and epoxy layer. A protective coating is typically applied to the press-formed substrate to create the finished mirror. By using replication masters that are made of optical glass or like materials the surface roughness of the replicated surface is dramatically improved over those produced using conventional replication masters.

A third method for fabricating low-scatter optical components starts with a mirror, including off-axis aspheric mirror that is formed from bare aluminum or another metal either with or without a thick coating of another material such as Nickel. The metal mirror is then machined to shape such as by diamond turning and then the mirror is super-polished to a very low surface roughness.

The result from these methods is an off-axis parabolic mirror surface that satisfies conditions one and two described below.

To characterize mirror quality, a measurement of encircled energy is used. In the case of an off-axis parabolic mirror, this measurement is obtained by first illuminating the mirror surface with a collimated beam. Once illuminated, the encircled energy value (or fractional energy value) is measured at focus, and at increasingly larger distances from the focus. The source of the measurement can be either a monochromatic or polychromatic source. Additional mirrors may be added to steer the beam. The measurement technique is included as an example and does not preclude other configurations that might be obvious to others skilled in the art.

The encircle energy is used to define a metric that is referred to as Total Surface Error or TSE. TSE is defined in terms of differences in encircled energy value between the manufactured part and an ideal diffraction-limited optical component of equal focal length and numerical aperture. In general, it has been found that mirrors constructed that meet the following two conditions produce greatly improved metrology system performance: 1) Condition one requires that: TSE≦2e^{0.15D} where D is the included diameter of the encircled energy measurement or twice the radius from the ideal focus point. 2) Condition two requires that TSE be a monotonically decreasing function of D (included diameter). This eliminates significant mid-spatial frequency errors such as periodic structures in the optical surface contour often seen in commercially available off-axis parabolic mirror surfaces.

Components may be made by any three methods described above to satisfy conditions one and two. Use of these components yields dramatically reduced scattered light and markedly increase performance in metrology instruments such as spectroscopic ellipsometers.

### BRIEF DESCRIPTION OF THE DRAWINGS

FIG. 1 is a block diagram of a prior art off-axis parabolic mirror.

FIG. 2A shows a prior art off-axis parabolic mirror and its associated mounting fixture.

FIG. 2B shows a prior art off-axis elliptical mirror and its associated mounting fixture.

FIG. 3 shows a comparison between commercially available diamond turned paraboloids and a mirror formed using a method provided by an embodiment of the present invention.

FIG. 4 shows an off-axis parabolic mirror formed using a method provided by an embodiment of the present invention.

FIG. 5 shows a die used to form an off-axis parabolic mirror as provided by an embodiment of the present invention.

FIG. 6 shows a broadband ellipsometer constructing using the low noise optical components provided by the present invention.

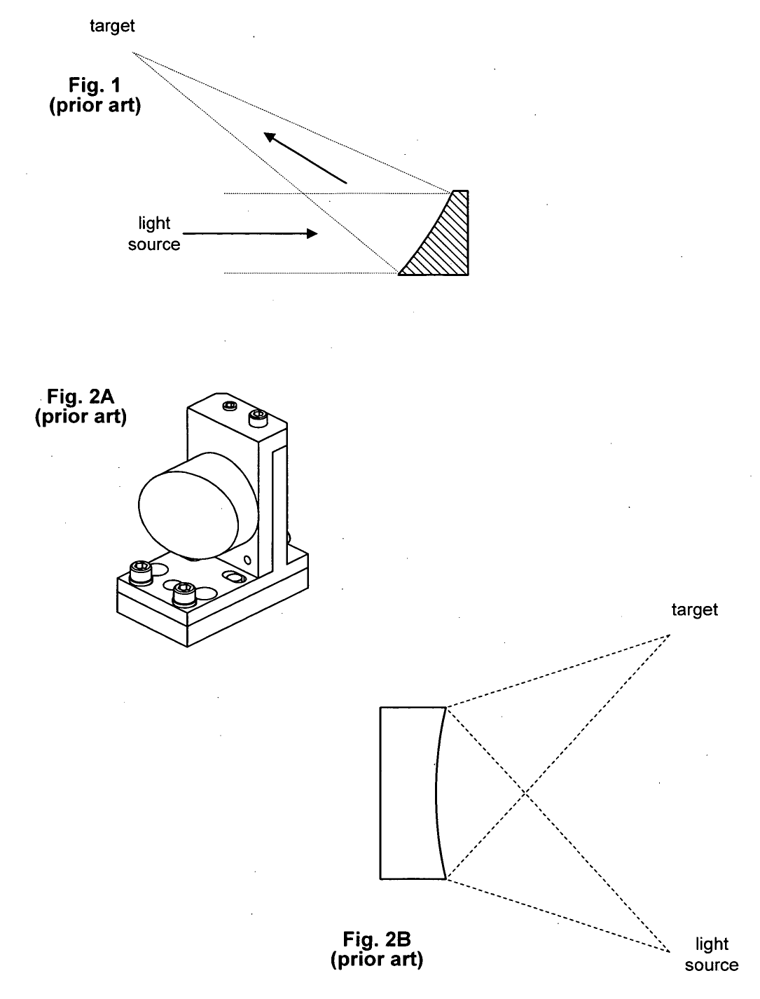

### DETAILED DESCRIPTION OF THE PREFERRED EMBODIMENTS

The present invention provides a method for increasing the accuracy of optical metrology tools. For this method, low scatter mirrors are produced using one of the fabrication methods discussed below. The low scatter mirrors are used in place of traditional optics to reduce optical noise. In turn, this allows measurement accuracy to be increased while maintaining or decreasing measurement spot size.

To characterize mirror quality, a measurement of encircled energy is used. In the case of an off-axis parabolic mirror, this measurement is obtained by first illuminating the mirror surface with a collimated beam. Once illuminated, the encircled energy.value (or fractional energy value) is measured at focus, and at increasingly larger distances from focus relative to an infinitely large encircled energy diameter including 100% of the incident energy. The encircle energy is used to define a metric that is referred to as Total Surface Error or TSE. TSE is defined in terms of differences in encircled energy value between the manufactured part and an ideal diffraction-limited optical component of equal focal length and numerical aperture. More formally:

$$TSE ( D ) = \frac{{E}_{subject} ( D )}{{E}_{ideal} ( D )}$$

where E_{subject} (D) is the encircled energy measured for a subject mirror at diameter D and E_{ideal} (D) is the energy encircle by an ideal diffraction-limited mirror at the same diameter D.

Empirically, it has been found that improvements in metrology system performance may be obtained if mirrors are constructed so that their total surface error (TSE) satisfies two conditions. The first condition sets an upper bound on the allowable TSE, namely: TSE(D)≦2e^{-0.15D}. The second condition requires that TSE is a monotonically decreasing function of the included diameter (D). This eliminates significant mid-spatial frequency errors such as periodic structure in the optical surface contour often seen in commercially available off-axis parabolic mirror surfaces.

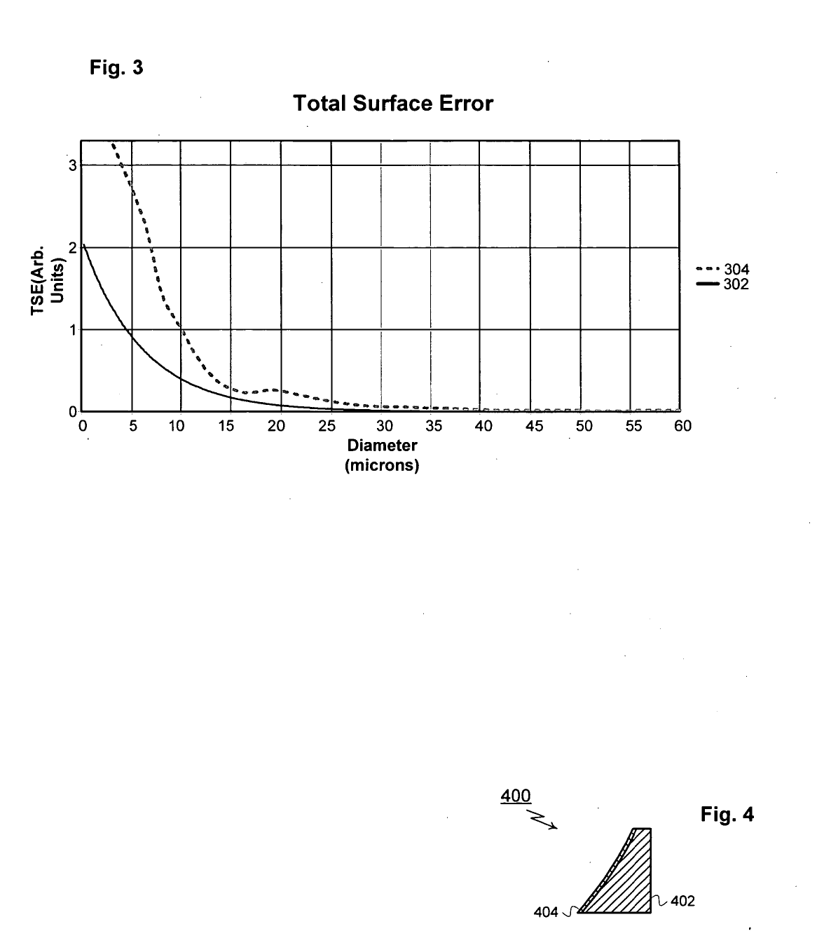

FIG. 3 shows two curves. The first, labeled 302 corresponds to the function TSE(D)=2e^{-0.15D}. The second, labeled 304 corresponds to the TSE function measured empirically for a diamond turned paraboloid. As may be appreciated from that figure, the TSE function for the diamond turned paraboloid violated both of the conditions described above. For example, at the ten-micron diameter, the diamond turned parabola has a TSE of approximately one. The desired TSE at that point is 0.45 or below. At twenty microns, that TSE for the diamond turned optic is approximately 0.2 compared to the desired value of 0.1. Thus it is clear that the diamond turned optic violates the first condition. The second condition (i.e., the requirement that TSE be monotonically decreasing) is also clearly violated by the undulating TSE of the diamond turned optic.

Components may be made by any three methods described above to satisfy conditions one and two. Use of these components yields dramatically reduced scattered light and markedly increased performance in metrology instruments such as spectroscopic ellipsometers. In particular, use of these components enables the construction of optical metrology systems in which 99% or more of energy reflected by the sample reaches the detector. This allows measurement of Angstrom and sub-Angstrom features and measurement spot sizes of fifty microns and below.

One method for producing appropriate mirrors (including off-axis aspheric mirrors) starts with a glass substrate. Each glass substrate is machined to create the desired shape. Typically, this is performed using computer-numeric-control (CNC) techniques. Each machined substrate is then coated with a reflective coating, such as aluminum and protected with a sealer (e.g., SiO₂ or MgF₂). The overall result is shown in FIG. 4 where off-axis parabolic mirror 400 includes a glass substrate 402 and an aluminum coating 404. Mirrors of this type have superior surface smoothness reducing noise and distortion within optical metrology systems. This is particularly relevant where ellipsometers are used for the measurement of optical properties of thin films with sub-Angstrom features.

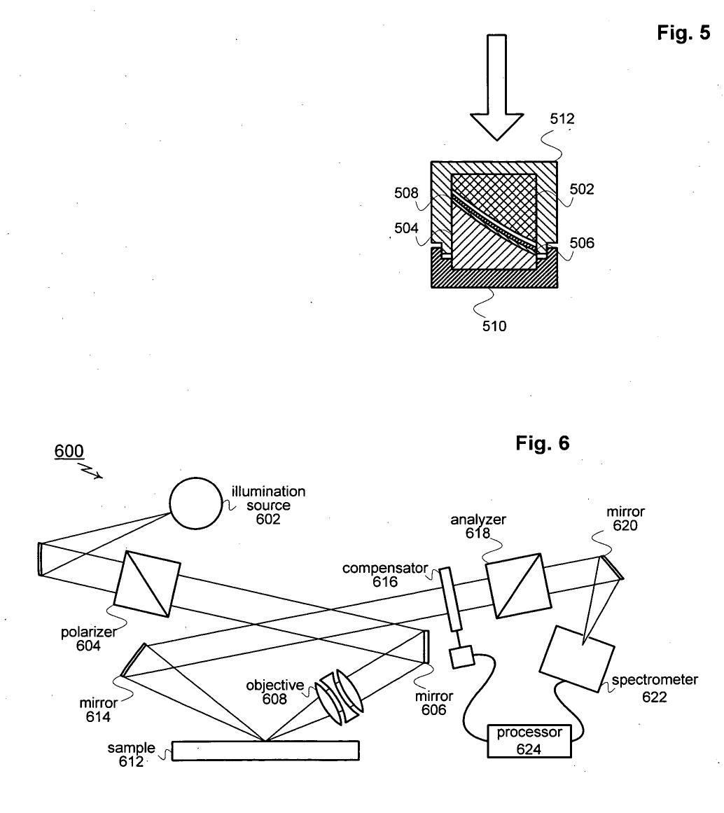

As shown in FIG. 5, a second method for fabricating low-noise optical components uses a press forming technique to create mirrors from deformable coatings. The press forming technique uses a two part die that includes a male half 502 (or master) and a female half 504. The female half of the die is a preformed substrate that will be part of the finished mirror. A deformable coating 506 and compliant adhesive layer (e.g., epoxy) 508 are position over the substrate 504. The die is then closed, imparting the shape of the master 502 into the deformable coating 506. Mold/mandril halves 510, 512 provide alignment, centering and bond line control of the finished assembly.

To reduce surface roughness, the male half 502, also referred to as the master is made of optical glass. The optical glass master 502 may be formed using a range of fabrication techniques including traditional grinding and polishing and/or more modem CNC optical production methods and super-polishing. By using replication masters that are made of optical glass or like materials the surface roughness of the replicated surface is dramatically improved over those produced using conventional replication masters. In addition, optical fabrication techniques traditionally generate more precise surfaces than those used for the fabrication of other materials and as such the physical angles and dimensions of optics made using this technique are better than those made by traditional replication techniques.

The press forming technique provides a rapid, economical method for producing high quality mirrors including high precision off-axis paraboloids. Using replicated optics of this type in place of diamond turned or otherwise manufactured optical components (specifically off-axis paraboloids) yields improved system performance in terms of lower scatter and thus higher precision in such applications as spectroscopic ellipsometry or broad band ellipsometry for the measurement of optical properties of thin films where sub-Angstrom features are measured. The use of replicated optics can also yield an overall reduction in the overall cost of ellipsometers and related optical metrology systems.

A third method for fabricating low-noise optical components starts with a mirror that is formed from bare aluminum or similar material or a plated aluminum or similar material. The aluminum mirror is machined to the desired shape and then super-polished to a very low surface roughness minimizing the periodic structure that is typically imparted during diamond turning. This approach can be applied to the production of high precision off-axis paraboloids, and other optics, that yield superior surface roughness when compared to diamond turning or other post polishing processes in general, and diamond turning and conventional grinding and polishing in specific.

FIG. 6 shows a broadband ellipsometer 600 that includes the low noise optical components described above. Ellipsometer 600 includes a broadband illumination source 602 that produces a polychromatic probe beam. The probe beam is passed through a polarizer 604 which imparts a known polarization state and is redirected by a flat mirror 606. The probe beam is then focused by an objective assembly 608 on the surface of a sample 610.

A mirror 614 gathers and collimates the reflected probe beam. Mirror 614 is typically an off-axis paraboloid of the type described above. The probe beam is then passed through a rotating compensator (waveplate) 616 and an analyzer 618. The combination of rotating compensator 616 and analyzer 618 allow ellipsometer 600 to detect changes in the polarization state of the probe beam, induced by its interaction with sample 612. A mirror 620 (also typically an off-axis paraboloid) redirects the probe beam to a spectrometer 622. Spectrometer produces signals that describe the received probe beam and its changed polarization state. A processor 624 analyzes these signals to deduce physical properties of sample 612.

For advanced semiconductors, broadband ellipsometer 600 is preferably configured to support a measurement spot size of less than 50 microns. This means that mirror 614 gathers illumination from within a 50 micron spot on the surface of sample 612. Within that measurement spot, ellipsometer 600 is preferably configured to measure sub-Angstrom features. Achieving this accuracy requires careful control of the illumination within ellipsometer 600. A rule of thumb may be used that states that the percent of scattered energy is approximately equal to the thickness in Angstroms with which measurements may be made (i.e., scatter in percent=thickness accuracy in Angstroms). Thus, if it assumed that an accuracy of one Angstrom is desired, then scattered illumination cannot exceed one percent. For the particular example of FIG. 6, that one percent would be spread over all of the optical components between sample 612 and spectrometer 622 (i.e., mirror 614, compensator 616, analyzer 618 and mirror 620). By using the low noise optics described above, that meet conditions one and two described above, ellipsometer 600 is able to achieve the required accuracy. Of course, ellipsometer is just one example of a metrology device that can use this technique. Many other variants are known to those skilled in the art.

1. An apparatus for optically inspecting a sample, the apparatus comprising:
an illumination source that generates a probe beam;
a series of optical components that cause a portion of the probe beam to be reflected by a measurement area on the sample surface and subsequently transported to a detector, where the series of optical components includes at least one mirror, meeting the condition TSE(D)≦2e^{-0.15D} where TSE(D)=Eₘᵢᵣᵣₒᵣ(D)/E_{ideal}(D) where Eₘᵢᵣᵣₒᵣ(D) is the encircled energy of the mirror measured as a function of the included diameter D and E_{ideal}(D) is the encircled energy for an ideal diffraction-limited mirror of equal focal length and numerical aperture; and
a processor for analyzing signals generated by the detector.

2-6. (canceled)

7. An apparatus for optically inspecting a sample, the apparatus comprising:
an illumination source that generates a probe beam;
a first series of optical components that direct the probe beam to be reflected by the sample;
a second series of optical components that gather the reflected probe beam from a measurement area on the sample surface, where the series of optical components includes at least one mirror, and where the series of optical components transports at least 99% of the gathered illumination to a detector; and
a processor for analyzing signals generated by the detector.

8-14. (canceled)

15. An apparatus for optically inspecting a sample, the apparatus comprising:
an illumination source that generates a probe beam;
a series of optical components that cause a portion of the probe beam to be reflected by a measurement area on the sample surface and subsequently transported to a detector, where the series of optical components includes at least one mirror, and where at least 99% of the portion of the probe beam that is reflected by the measurement area reaches the detector; and
a processor for analyzing signals generated by the detector.

16-47. (canceled)
